(19) United States
(12) Patent Application Publication
(10) Pub. No.: US 2007/0095482 A1
(43) Pub. Date: May 3, 2007

(54) Label applicator

(76) Inventor: Frances H. Benton, Keene, NH (US)

Correspondence Address: FISH & RICHARDSON PC, P.O. BOX 1022, MINNEAPOLIS, MN, 55440-1022, US

(21) Appl. No.: 11/262,333

(22) Filed: Oct. 28, 2005

(51) Int. Cl. B65C 9/36; B65C 1/00

(52) U.S. Cl. 156/539; 156/540; 156/541; 156/DIG. 1; 156/DIG. 24; 156/DIG. 37; 156/DIG. 42

(57) ABSTRACT

A label applicator includes a tamp applicator having a face plate for receiving a label moving in a first direction; and a barrier on the face plate to limit motion of the label along the first direction.

### FIELD OF INVENTION

This invention relates to application of labels, and in particular, to removing adhesive labels from a web.

### BACKGROUND

Adhesive labels are often packaged on long strips, called webs. These webs are generally sold in rolls that are mounted on a labeling machine.

In a typical labeling machine, the web is threaded between a feed spool and a take-up spool. The portion of the web wound on the feed spool is laden with adhesive labels. The portion of the web wound around the take-up spool ideally has no labels at all. Between the feed spool and the take-up spool is a label dispenser. In operation, the web travels between the feed spool and the take-up spool. At the label dispenser, labels are peeled off the web and applied to an applicator. In the case of a tamp applicator, the applicator is a tamping member that receives the label and tamps it on a package.

A typical label dispenser includes a peel-bar having an edge that contacts the moving web. In operation, the web, laden with labels, approaches the edge on one side of the peel-bar. At the edge, the web executes a turn, which causes a label to be peeled off the web.

During the peeling process, a separation line on the label divides the label into two portions: a peeled portion, which is no longer attached to the web, and an unpeeled portion, which remains attached to the web. The separation line begins at the leading edge of the label and moves progressively backward, toward the trailing edge of the label. As it does so, the peeled portion lengthens and the unpeeled portion of the label shortens. When the separation line reaches the trailing edge, the peeling is complete.

When the separation line meets the trailing edge of the label, the last line of adhesive often stays stuck to the web. This results in labels that remain on the web, held only by the last line of adhesive, as the web moves away from the peel-bar. Consequently, products that should have been labeled remain unlabeled. In addition, the presence of labels dangling from the web with their sticky sides exposed increases the likelihood of label jams in the dispenser.

### SUMMARY

In one aspect, the invention includes an apparatus having a tamp applicator having a face plate for receiving a label moving in a first direction; and a barrier on the face plate to limit motion of the label along the first direction.

Among the embodiments of the apparatus are those having channels on the face plate, and a manifold for distributing moving air among the channels. Such a manifold can be configured to direct moving air in the first direction, or to direct moving air in a direction opposite to the first direction.

The barrier can take a variety of forms. For example, some embodiments have a lip as a barrier. Such a lip can extend across the face plate. The barrier can be disposed at a variety of locations. Some embodiments feature a barrier that is disposed to engage the label while a portion of the label is attached to a web.

The height of the lip can also vary. In some embodiments, the lip has a height that is less than the thickness of the label; in others, the lip has a height between 60% and 90% of the thickness of the label.

Other embodiments of the apparatus include those having a tamping arm coupled to the tamp applicator. The tamping arm causes the tamp applicator to move between a first position, in which the tamp applicator is disposed to receive the label, and a second position, in which the tamp applicator is disposed to apply the label to a substrate.

In another aspect, the invention includes a labeling machine having a label applicator in which a tamp applicator has: a face plate for receiving a label moving in a first direction; and a barrier on the face plate to limit motion of the label along the first direction.

Another aspect of the invention features an apparatus having a tamp applicator having a face plate for receiving a label moving in a first direction; and means for limiting motion of the label along the first direction.

Yet another aspect of the invention includes a method of removing an adhesive label from a web. The method includes receiving a leading portion of a label, the label having a trailing portion adhered to a web; the leading portion being free of the web and moving in a first direction; and limiting motion of the leading portion along the first direction, thereby causing application of a force tending to free the trailing portion from the web.

Among the practices of this method are those in which a partial vacuum is applied to urge the label in a direction having a component perpendicular to the first direction. Such a partial vacuum can be applied, for example, by directing moving air along one face of the label.

In other practices, limiting motion of the leading portion includes providing a barrier to engage a leading edge of the label. Providing such a barrier can include selecting a height of the barrier to be less than the thickness of the label.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

FIG. 1 is a diagram that shows labels adhering to a web;

FIG. 2 is a diagram that shows a label being peeled off a web;

FIG. 3 is a diagram that shows a tamp applicator receiving a label;

FIG. 4 is a diagram that shows the tamp applicator of FIG. 3 dispensing a label; and

FIG. 5 is a diagram that shows the air-distribution system of the tamp applicator of FIG. 3.

### DETAILED DESCRIPTION

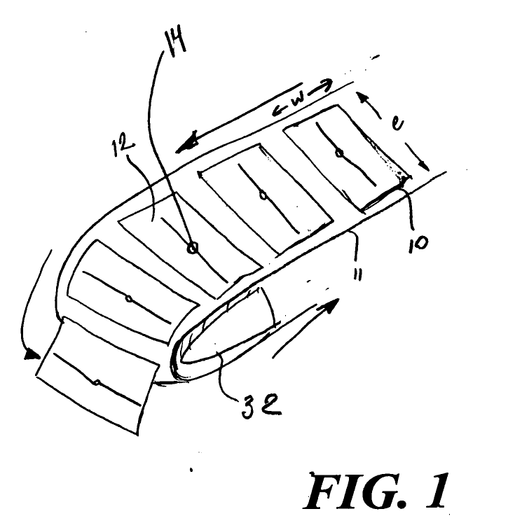

FIG. 1 shows labels 10 adhering to a web 11. The labels 10 have a width, w, that is much greater than their length, 1. Such labels 10 are commonly used for RFID (“Radio Frequency Identification) tags because the antennas 12 used in such tags are often much larger than the processing components of the RFID chip 14. One label that incorporates an RFID chip is 12.7 mm in width and 101.6 mm in length. Another such label is 12.7 mm in width and 152.4 mm in length. Other labels include those that are used in connection with the ALIEN I (TM) tag (13 mm wide and 100 mm long), the ALIEN SQUIGGLE (TM) Tag (16 mm wide and 156 mm long), and the ALIEN D (TM) tag (16 mm side and 165 mm long), all of which are available from Alien Technology of Morgan Hill, California.

In an effort to maximize the number of labels 10 per unit length of web 11, these labels 10 are often placed on the web 11 with their shorter dimension extending parallel to the web's direction of motion. This preferred orientation causes difficulty in peeling the label 10 off the web 11.

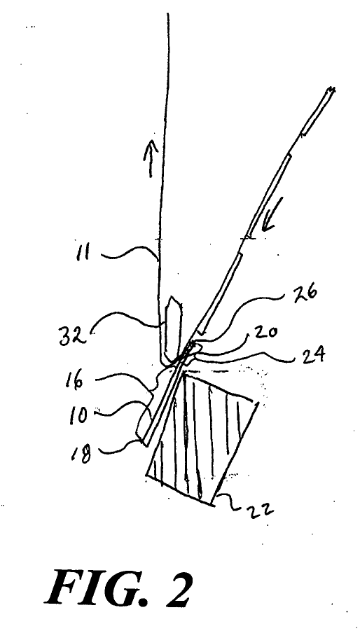

FIG. 2 shows a label 10 in the process of being peeled off the web 11. A leading portion 16 of the label 10, extending between a leading edge 18 and a separation line 20, is already off the web 11 and presented to an applicator 22. A trailing portion 24 of the label 10, extending from the separation line 20 to a trailing edge 26, remains on the web 11. In some embodiments, a partial vacuum draws the label towards the applicator 22.

As shown in FIG. 2, the leading portion 16 of the label 10 functions as a moment arm for transmitting a torque about the separation line 20. This torque assists in peeling the trailing portion 24 of the label 10. As the separation line 20 moves backward, the leading portion 16 becomes progressively longer. Thus, the torque at the separation line 20 becomes larger. The torque is augmented by the vacuum in the applicator 22.

In the case of a label 10 having an aspect ratio and orientation as shown in FIG. 1, the leading portion 16 of the label 10 never becomes very long. As a result, it is sometimes difficult to generate sufficient torque to completely peel the label 10 off the web 11. This difficulty is further exacerbated in labels that hold RFID tags because such labels tend to be relatively stiff.

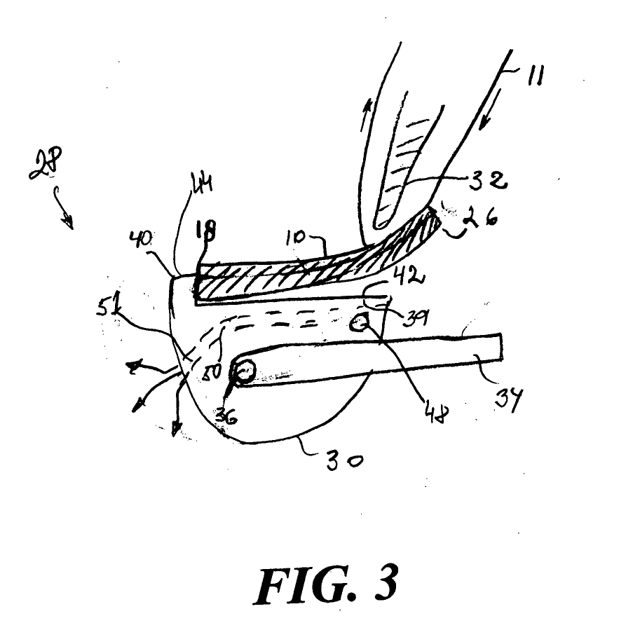

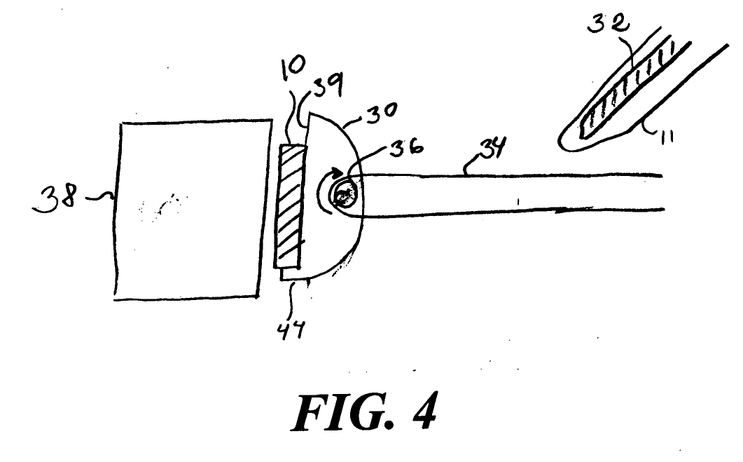

FIG. 3 shows an applicator 28 in which a tamp applicator 30 is disposed to receive a label 10 that is peeled from a web 11 as the web 11 executes a hairpin turn around a peel bar 32. The tamp applicator 30 is rotatably coupled to a tamping arm 34 at a joint 36. The tamp applicator 30 moves between a receiving position, shown in FIG. 3, in which it receives a label 10, and a tamping position, shown in FIG. 4, in which it is ready to apply the label 10 to a package 38. The tamping arm 34 translates and rotates the tamp applicator 30 between the receiving position and the tamping position.

The tamp applicator 30 has a face plate 39 for supporting the label 10.The face plate 39 has a transversely-extending front edge 40 and a transversely-extending back edge 42. Extending parallel to the front edge 40 is a barrier 44 that catches the leading edge 18 of the label 10.

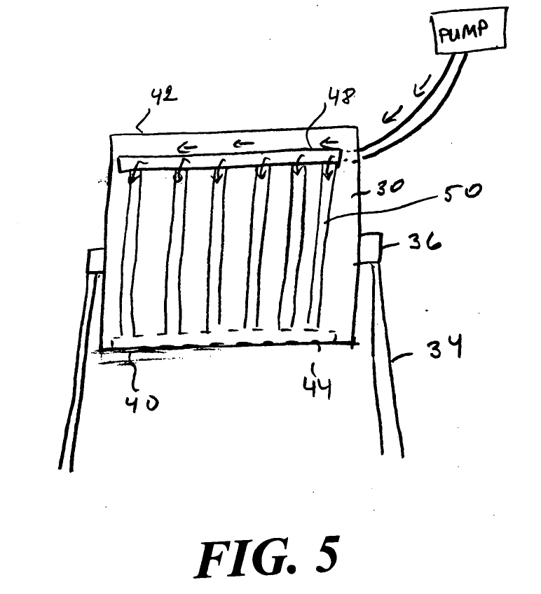

The tamp applicator 30 also includes a vacuum system 46, best seen in FIG. 5, having a transversely extending manifold 48 that directs moving air through channels 50. In FIG. 5, the channels 50 are shown as extending between the front edge 40 and the back edge 42 of the face plate 39. However, the channels 50 can be oriented in any direction, including transversely across the face plate 39, or at a diagonal. Air moving along these channels 50 creates a partial vacuum that holds the label 10 on the face plate 39. The channels 50 further include an angled portion 51 to direct air away from the label 10, thereby preventing the label 10 from fluttering while it is on the face plate 39.

In operation, as the label 10 peels off the web 11, the leading edge 18 of the label 10 engages the barrier 44, as shown in FIG. 3. The barrier 44 resists further forward motion of the label 10. The leading portion 16 of the label 10 transmits the resistive force provided by the barrier 44 back to the separation line 20. This resistive force thus results in a shear force that assists in moving the separation line 20 back toward the trailing edge 26 of the label 10, thereby enhancing the likelihood that the label 10 will be peeled off the web 11 successfully. In addition, air moving along the channels 50 exerts a negative pressure that tends to suck the label 10 toward the face plate 39. This negative pressure helps prevent the label 10 from bowing outward, away from the face plate 39.

As the web 11 continues to drive the trailing edge of the label 10 forward, the shear force increases further. In effect, the label 10 becomes a leaf spring exerting the shear force. Eventually, the shear force overcomes the force of the adhesive holding the label 10 to the web 11, and the label 10 peels off the web 11 completely. The negative pressure then sucks the label 10 flat against the face plate.

Once the label 10 is on the face plate 39, the tamping arm 34 swivels the tamp applicator 30 from the first position, shown in FIG. 3, to the second position, shown in FIG. 4. The tamping arm 34 then translates the tamp applicator 30 toward the package 38 until the adhesive face of the label 10 contacts the package 38. The tamping arm 34 then withdraws the tamp applicator 30, leaving behind the label 10 on the package 38, and moves the tamp applicator 30 back into the first position to receive the next label 10.

In alternative embodiments, the tamp applicator 30 is already oriented correctly for placement of the label on the package 38. In such embodiments, the tamping arm 34 need not swivel the tamp applicator 30, and the tamp applicator 30 need only be translated into position.

The barrier 44 extends outwardly from the face plate 39 to an extent that is less than the thickness of the label 10. If the barrier 44 fails to extend outward sufficiently, it will fail to engage the label 10 sufficiently to block forward motion of the label 10. Instead, the label 10 will simply slide over the barrier 44. If, on the other hand, the barrier 44 is taller than the label 10 is thick, then the tamping arm 34 will be unable to place the label 10 in contact with the package 38. Suitable ratios between the thickness of the label 10 and the height of the barrier 44 range between 60% and 90%. For a label 10 that is 0.006 inches thick, a suitable height of the barrier 44 is 0.005 inches.

As shown, the barrier 44 is a continuous lip extending all the way across the face plate 39. However, this need not be the case. The barrier 44 can be a discontinuous lip, or a lip that extends only partway across the face plate 39. Or, the barrier 44 can be a pair of pins or other obstructions. The barrier 44 need not be permanently in place. For example, the barrier 44 can be made retractable. In such a case, the barrier 44 height can be made equal to or greater than the thickness of the label 10 since the barrier 44 could then be retracted to a suitable height, or retracted all the way, just before the label 10 is applied to the package 38.

Also as shown, the cross-section of the barrier 44 features a vertical wall. However, the cross-section of the barrier 44 can be varied in response to variations in the profile of the label 10. The cross-section can also be a line that meets the face plate 39 at an angle other than ninety degrees, or the cross-section can form a curve shaped to engage the label 10.

In other embodiments, the barrier 44 need not extend upwards at all. The barrier 44 may be, for example, a portion of the face plate 39 having a coefficient of friction that is sufficient to engage the label 10 and to resist forward motion thereof. Or, the barrier 44 may be a portion of the face plate 39 having an adhesive layer that likewise engages the label 10 and resists forward motion thereof.

Other embodiments of the barrier 44 are those in which an electrostatic charge is applied to the label 10 and an opposed electrostatic charge is applied at the front edge of the face plate 39, thereby causing an electrostatic force that resists forward movement of the label 10.

In yet other embodiments, the channels can be constricted toward the front edge of the face plate 39, so that the air velocity, and hence the suction force, is greater at the front edge. In that case, the suction force is made strong enough to resist forward motion of the label 10. In such a case, the air velocity can be varied so that the suction force is reduced when the label 10 is being tamped onto the package 38 and greatest when the label 10 is being peeled off the web.

As shown in FIG. 3, the manifold 48 is under the back edge 42 of the tamp applicator 30, so that air flows in a direction from the back edge 42 toward the front edge 40. However, the manifold 48 can also be under the front edge 40 so that air flows in the opposite direction. Or, the vacuum system 46 can be one in which channels 50 extend transversely across the tamp applicator 30, or in a direction that has both a transverse and longitudinal direction relative to the tamp applicator 30.

The velocity of air in the channels 50 depends on such factors as the size and weight of the label 10, the stiffness of the label 10, and the strength of the adhesive on the label 10. The velocity is selected to be high enough to secure the label 10 against the tamp applicator 30, but not so high that the label 10 is sucked into the channels 50 and deformed.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

Having described the invention, and a preferred embodiment thereof, What I claim as new and secured by Letters Patent is:

1. An apparatus comprising:
a tamp applicator having a face plate for receiving a label moving in a first direction; and
a barrier on the face plate to limit motion of the label along the first direction.

2. The apparatus of claim 1, further comprising a plurality of channels on the face plate, and a manifold for distributing moving air among the channels.

3. The apparatus of claim 2, wherein the manifold is configured to direct moving air in the first direction.

4. The apparatus of claim 2, wherein the manifold is configured to direct moving air in a direction opposite to the first direction.

5. The apparatus of claim 1, wherein the barrier comprises a lip.

6. The apparatus of claim 5, wherein the lip is a continuous lip extending across the face plate.

7. The apparatus of claim 5, wherein the lip has a height that is less than the thickness of the label.

8. The apparatus of claim 5, wherein the lip has a height between 60% and 90% of the thickness of the label.

9. The apparatus of claim 1, wherein the barrier is disposed to engage the label while a portion of the label is attached to a web.

10. A labeling machine having a label applicator as recited in claim 1.

11. The apparatus of claim 1, further comprising a tamping arm coupled to the tamp applicator for causing the tamp applicator to move between a first position, in which the tamp applicator is disposed to receive the label, and a second position, in which the tamp applicator is disposed to apply the label to a substrate.

12. An apparatus comprising:
a tamp applicator having a face plate for receiving a label moving in a first direction; and
means for limiting motion of the label along the first direction.

13. A method of removing an adhesive label from a web, the method comprising:
receiving a leading portion of a label, the label having a trailing portion adhered to a web; the leading portion being free of the web and moving in a first direction; and
limiting motion of the leading portion along the first direction, thereby causing application of a force tending to free the trailing portion from the web.

14. The method of claim 13, further comprising applying a partial vacuum to urge the label in a direction having a component perpendicular to the first direction.

15. The method of claim 14, wherein applying a partial vacuum comprises directing moving air along one face of the label.

16. The method of claim 13, wherein limiting motion of the leading portion comprises providing a barrier to engage a leading edge of the label.

17. The method of claim 15, wherein providing a barrier comprises selecting a height of the barrier to be less than the thickness of the label.
